(19) United States
(12) Patent Application Publication
(10) Pub. No.: US 2025/0238574 A1
(43) Pub. Date: Jul. 24, 2025

(54) CALIBRATING THE TOPOLOGICAL GAP PROTOCOL BY OPTIMIZING THE TOPOLOGICAL GAP

(71) Applicant: Microsoft Technology Licensing, LLC, Redmond, WA (US)

(72) Inventors: Amin BARZEGAR, Redmond, WA (US); Dmitry PIKULIN, Vancouver (CA); Andrey ANTIPOV, Santa Barbara, CA (US); Georg Wolfgang WINKLER, Santa Barbara, CA (US); Konstantin KALASHNIKOV, Redmond, WA (US); Roman Mykolayovych LUTCHYN, Santa Barbara, CA (US); William Scott COLE, JR., Sammamish, WA (US)

(21) Appl. No.: 18/615,473

(22) Filed: Mar. 25, 2024

Related U.S. Application Data
(60) Provisional application No. 63/624,376, filed on Jan. 24, 2024.

(51) Int. Cl. G06F 30/20; G06F 111/14; G06F 113/16; G06F 119/08; H10N 60/83; H10N 60/85

(52) U.S. Cl. CPC G06F 30/20; H10N 60/83; H10N 60/85; G06F 2111/14; G06F 2113/16; G06F 2119/08

(57) ABSTRACT

Methods and systems for calibrating a transport gap protocol (TGP) for a device design are described. An example method includes obtaining a non-local conductance threshold by identifying those topological regions of interest (ROIs) for the device design that have an optimized amount of overlap with a topological index associated with the device design. The method further includes thresholding a thermal conductance to obtain both: (1) an estimated topological gap for the device design, and (2) optimal topological ROIs for the device design. The method further includes using a processor, based on the obtained estimated topological gap and the obtained optimal topological ROIs, extracting a topological gap for calibrating the TGP for the device design.

### CROSS-REFERENCE TO A RELATED APPLICATION

This application claims the benefit of U.S. Provisional Application No. 63/624,376, filed Jan. 24, 2024, titled “SIMULATION-BASED EXTRACTION OF THE SPIN-ORBIT COUPLING AND CALIBRATION OF THE OPTIMAL TOPOLOGICAL GAP,” the entire contents of which are hereby incorporated herein by reference.

### BACKGROUND

Topological gap protocol (TGP) is used to identify whether there are regions in the experimental parameter space that show signatures consistent with a topological phase. In the topological phase of a superconducting wire, Majorana zero modes (MZMs) are localized at the boundaries between the topological section and the trivial section. Assuming that the physical length (L) of the wire is smaller than the localization length, one is likely to observe a nonzero bulk transport gap. As part of the TGP, the presence of MZMs and a bulk transport gap is detected by measuring certain differential conductances as a function of the plunger voltage and other control variables.

To reliably estimate the topological phase, extract the topological gap, and calculate the corresponding confidence intervals, one needs to threshold the conductance signal such that the conductance signal is sufficiently discernible from the inherent noise in the system. Without proper thresholding of such signals, the TGP may not reliably estimate the topological phase. Accordingly, there is a need for improvements to systems and methods for calibrating the TGP by optimizing the topological gap.

### SUMMARY

In one example, the present disclosure relates to a method for calibrating a transport gap protocol (TGP) for a device design. The method may include obtaining a non-local conductance threshold by identifying those topological regions of interest (ROIs) for the device design that have an optimized amount of overlap with a topological index associated with the device design.

The method may further include thresholding a thermal conductance to obtain an estimated topological gap for the device design. The method may further include using a processor, based on the obtained estimated topological gap, extracting a topological gap for calibrating the TGP for the device design.

In another example, the present disclosure relates to a method for calibrating a transport gap protocol (TGP) for a device design. The method may include obtaining a non-local conductance threshold by identifying those topological regions of interest (ROIs) for the device design that have an optimized amount of overlap with a topological index associated with the device design.

The method may further include thresholding a reference conductance to obtain an estimated topological gap for the device design by evaluating reference gapless regions that have an optimized amount of overlap with non-local conductance gapless regions associated with the device design. The method may further include using a processor, based on the obtained estimated topological gap, extracting a topological gap for calibrating the TGP for the device design.

In yet another example, the present disclosure relates to a method for calibrating a transport gap protocol (TGP) for a device design. The method may include obtaining a non-local conductance threshold by identifying those topological regions of interest (ROIs) for the device design that have an optimized amount of overlap with a topological index associated with the device design.

The method may further include thresholding a thermal conductance value to obtain an estimated topological gap for the device design by evaluating thermal conductance gapless regions that have an optimized amount of overlap with non-local conductance gapless regions associated with the device design. The method may further include using a processor, based on the obtained estimated topological gap and the obtained optimal topological ROIs, extracting a topological gap for calibrating the TGP for the device design.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 shows phase diagrams for different values of the threshold non-local conductance (c₀) as part of a method for calibrating a topological gap protocol (TGP) in accordance with one example;

FIG. 2 shows graphs illustrating the results of optimizing a cost function versus the threshold non-local conductance (c₀) for different hybrid superconductor-semiconductor device designs;

FIG. 3 shows a graph illustrating the propagation of errors from the cost function to the thresholds for the non-local conductance (c₀) in accordance with one example;

FIG. 4 shows phase diagrams for different values of the thermal conductance (c_{K}) as part of a method for calibrating a topological gap protocol (TGP) in accordance with one example;

FIG. 5 shows graphs illustrating the results of optimizing the cost function versus the threshold thermal conductance (c_{K}) for different hybrid superconductor-semiconductor device designs;

FIG. 6 shows phase diagrams for different values of the topological gap threshold (c_{Δ}) in accordance with one example;

FIG. 7 shows graphs illustrating the results of optimizing the cost function versus the topological gap threshold (c_{Δ}) for two different hybrid superconductor-semiconductor device designs;

FIG. 8 is a block diagram of an example computing system for implementing the steps associated with calibrating the TGP;

FIG. 9 is a flowchart of a method for calibrating a transport gap protocol (TGP) for a device design in accordance with one example; and

FIG. 10 is a flowchart of another method for calibrating the TGP for a device design in accordance with one example.

### DETAILED DESCRIPTION

Examples described in this disclosure relate to systems and methods for calibrating the topological gap protocol (TGP) by optimizing the topological gap. Topological devices can be used to enable quantum computers. Such quantum computers require reliable reproduction of a stable topological phase of the matter that supports non-Abelian quasiparticles or detects and processes quantum information through protected operations, such as braiding.

Certain topological devices can be used to support two phases-one trivial and the other topological. As used herein, the terms topological and trivial refer to the phases of the superconductor sections (e.g., nanowire sections) that are tuned using electrostatic gates to form topological or trivial superconducting sections. Topological devices allow one to measure a topological phase transition in a 2-dimensional electron gas (2DEG) nanowire device with a single or multiple occupied sub-bands and normal-superconducting (NS) junctions for probing the device from the sides. As an example, the wire is defined by the combination of a narrow superconducting strip and one or more layers of gate electrodes. These gate electrodes deplete the surrounding 2DEG, confining the strip in a channel under the superconductor and controlling the chemical potential in the nanowire. The superconducting strip (partly) screens the electric fields from the gate electrodes defining a wire. At the same time, the superconducting strip induces superconductivity via the proximity effect. Another set of gates can be used to open and close the junction and optionally control the chemical potential in the attached quantum dots. The device can then be used, among other things, to create a Majorana zero mode-based quantum computer having qubits.

Majorana zero mode (MZM) qubits require rapidly configuring couplings between different pairs of MZMs for qubit operations and measurement. As used herein, the term qubit refers to any quantum system that can be in a superposition of two quantum states, 0 and 1. As an example of devices that can be used with such a quantum system, topological devices formed from a single superconducting wire patterned on a two-dimensional electron gas (2DEG) are described. Different segments of the wire can be tuned using electrostatic gates to form trivial or topological superconducting sections, with Majorana zero modes at their interface. These gates can also be used to control the density in the 2DEG to deplete certain sections and define semiconducting regions that can form tunnel junctions. Each qubit may store information in either four or six Majorana zero modes (MZMs) and can be measured in any Pauli basis.

The topological device may be operated such that Majorana zero modes (MZMs) are formed at the ends of a section of the nanowire. In sum, electrostatic gates around the superconductor can be used to define an adjacent semiconducting region consisting of junctions, quantum dots, and transport leads, with all other parts of the 2DEG fully depleted. There are junctions between the MZMs and neighboring semiconductors (QDs or transport leads) and junctions between two semiconductors (QDs and transport leads). The plunger gates, the cutter gates, the quantum dot gates, and the helper gates can be supplied voltages via voltage waveforms generated by a control system associated with the topological device. Such a control system may include oscillators, switches, finite state machines, and a memory. As an example, the memory may be implemented as one or more multi-bit registers for allowing pulse-patterns to be stored.

As an example, the 2DEG underlying the gates may be manufactured by forming a series of layers of semiconductors on a substrate (e.g., using any of indium phosphide (InP) substrate, indium arsenide (InAs), indium antimonide (InSb), mercury cadmium telluride (HgCdTe), or any appropriate combination of materials selected from groups II, III, IV, V, or VI of the periodic table, or any ternary compounds of three different atoms of materials selected from groups II, III, IV, V, or VI of the periodic table). As an example, the 2DEG may further include a buffer layer (e.g., an indium aluminum arsenide (InAlAs) layer) formed over the substrate. The 2DEG may further include a quantum well layer (e.g., an indium arsenide (InAs) layer) formed over the buffer layer, and a barrier layer formed over the quantum well layer. Each of these layers may be formed using molecular-beam epitaxy (MBE). As an example, the MBE related process may be performed in an MBE system that allows the deposition of the appropriate materials in a vacuum.

In sum, such devices are fabricated from high-mobility two-dimensional electron gases in which quasi-one-dimensional wires are defined by electrostatic gates. These devices enable measurements of local and non-local transport properties and can be optimized via extensive simulations to ensure robustness against nonuniformity and disorder. In general, a semiconductor-superconductor heterojunction suitable for testing may include the various electrostatic gates and at least three terminals for supporting electronic admittance and conductance measurements. Various segments of a device including these features may be coupled to various probes for supplying control signals and receiving measurement data. As an example, simultaneous measurement of the tunneling signatures of the topological phase at the two ends of the nanowire can be performed. Furthermore, the non-local conductance can provide information about the lowest energy of the extended states of the topological segment, which may be used as a proxy for the topological gap. Accordingly, some of the methods described herein do not directly measure the topological character of a system but instead measure a set of surrogate variables, which, from analytical calculations and numerical simulations, are known to correlate well to the topological invariant.

Topological gap protocol (TGP) is used to identify whether there are regions in the experimental parameter space that show signatures consistent with a topological phase. In the topological phase of the wire, MZMs are localized at the boundaries between the topological section and the trivial section. Assuming that the physical length (L) of the wire is smaller than the localization length, one is likely to observe a nonzero bulk transport gap. As part of the TGP, the presence of MZMs and a bulk transport gap is detected by measuring certain differential conductances as a function of the plunger voltage and other control variables. For additional context, a reference: Morteza Aghaee et al., InAs—Al hybrid devices passing the topological gap protocol, Phys. Rev. B 107, 245423 (2023) (referred to herein as the Aghaee reference) is incorporated herein by reference. Without limiting the scope of the incorporation by reference, specific portions of this reference are described or identified, as necessary.

Simulations can be used to quantify the reliability of TGP. As an example, transport simulations can include three-dimensional models of devices that include the electrostatic environment defined by the set of gate voltages for such devices. For a selected gate voltage set, transport simulations can be performed to calculate the scattering matrix of the system. The local and the non-local conductance values can then be obtained. The goal of some of the simulations is as follows: assuming the TGP returns a region of interest that passes the test associated with the signatures for the topological phase, what is the probability that such a region does not overlap with the topological phase. The goal of the TGP calibration is to set various thresholds that minimize this probability. Once the TGP has been calibrated, it can be used to assess whether this probability is low when the TGP is applied to a range of device types and parameters, different junction design, different material parameters, such as spin-orbit coupling and disorder strength. To compute this probability via simulations, one can compare the regions of interest with a topological index (referred to as the “scattering invariant”). The regions of interest can be classified as follows: if an ROI has any overlap with scattering invariant −1, then it is a true positive, otherwise it is a false positive. The false discovery rate (FDR) is the probability that an ROI is trivial. For a finite number (N) of devices one can estimate upper and lower bounds on the FDR with certain confidence intervals.

Majorana zero modes (MZMs) are supported at the opposite ends of a nanowire. The trivial and topological phases are separated by a quantum phase transition at Vₓ=\sqrt{μ²}+|Δ_{ind}|² which is necessarily accompanied by the closing of the bulk gap, where μ is the chemical potential in the nanowire. The stability of a topological phase is characterized by its bulk transport gap, or equivalently, the gap to extended excited states, which is referred to herein as the topological gap Δ_{T}. The topological phase has been proposed to occur in quasi-one-dimensional systems composed of chains of magnetic atoms on the surface of a superconductor; in nanowires that are completely encircled by a superconducting shell in which the order parameter winds around the wire due to the orbital effect of the magnetic field; and in the vortex cores of three-dimensional superconductors. The corresponding two-dimensional topological superconductor state can occur in p+ip superconductors, at the surface of a topological insulator, in ferromagnetic insulator-semiconductor-superconductor heterostructures, and in s-wave superfluids of ultracold ferionic atoms.

The transport gap protocol (TGP) is a procedure that yields a yes/no answer to the question of whether a putative topological phase has been identified, the typical value of the topological gap, and the parameter regions in the space of gate voltages and magnetic field applied to the device where the topological region is present. The TGP presents much stricter requirements for the device to be identified as a topological superconductor than the presence of a zero-bias peak (ZBP), and thus increases the likelihood for the identified phases to host genuine MZMs. Notably, however, the parameter space of a typical device aimed at the detection and manipulation of MZMs is large—at least three gates (e.g., a left cutter gate, right cutter gate, and a plunger gate) and the magnetic field to control the state of the system. All such parameters need to be scanned to search for the topological parameter regime. As an example, the Aghaee reference describes several three-terminal semiconductor-superconductor nanowire devices, any of which can be subjected to the TGP protocol, as described in the Aghaee reference.

Instead of performing time-consuming local conductance measurements as part of scanning the topological parameter regime, one can use radio frequency (RF) reflectometry techniques to measure surrogates for local conductance measurements. Thus, the TGP can be performed in two states: (1) a first stage based on the measurements of the local signals at RF frequencies, and (2) a second stage based on the measurement of the full conductance matrix at near-DC frequencies. This separation narrows down the region of parameter space where the slower non-local conductance measurements are performed.

In one example of the TGP, the first stage of the TGP includes four steps. The first step includes performing calibration between RF and DC conductance measurements. The second step includes performing an RF reflectometry measurement of the local conductances on the left and on the right sides of the device as a function of the bias, the corresponding cutter gate voltages, the plunger gate voltage, and the magnetic field, and then mapping the measured RF signals to local conductances using the calibration data. The third step includes finding the positions at which zero bias peaks occur in the local conductances. The fourth, and the last, step includes grouping the zero bias peaks into regions and checking if there are regions of interest (ROI) where zero-bias peaks (ZBPs) are present on both sides of the wire. This step cuts off some of the false positives discussed previously as only disorder accidentally causes simultaneous ZBPs on both sides of the wire. The output of the first stage of the TGP is a sequence of regions of interest specified by ranges of gate voltages and the magnetic field.

The input for the second stage of the TGP is the output of the first stage: a list of regions of interest (ROI₁)—regions specified by minimal and maximal magnetic fields and plunger gate voltage values. For each region of interest (ROI₁), cutter gate values (e.g., assuming the three-terminal device has two cutter gates, then a cutter-pair index may be used to track the voltage values for the two cutter gates) for which the region is most visible are used. The full conductance matrix is then measured in these regions and analyzed for the presence of zero-bias peaks (ZBPs) and the size of the gap, which is used to define a list of sub-regions of interest (SOI₂). These sub-regions of interest (SOI₂) are further defined in order to extract the size of the topological gap for all of the points measured in the second stage of the TGP by thresholding the non-local conductance.

Next, the parent gap (Δ₀) is determined as a function of the magnetic field (B) at a sufficiently negative voltage where the non-local conductance shows a featureless gap closing. Next, the sub-regions of interest (SOI₂) are defined by clustering points that not only have ZBPs on both sides of the device (as in stage 1) but also show a topological gap Δₘᵢₙ<Δₑₓ<Δₘₐₓ, where Δₑₓ is the extracted topological gap (e.g., measured in μeVs) as a function of the plunger gate voltage. The topological gap Δₘᵢₙ can be viewed as a bar for calling a point gapless, which can be set to a certain value based on the experimental data and other analysis. The topological gap Δₘₐₓ can be chosen to be a fraction of the parent gap Δ₀, since the topological gap is expected to be smaller than the parent gap.

To reliably estimate the topological phase, extract the topological gap, and calculate the corresponding confidence intervals, one needs to threshold the conductance signal such that the conductance signal is sufficiently discernible from the inherent noise in the system. Without proper thresholding of such signals, the TGP may not reliably estimate the topological phase. Accordingly, there is a need for improvements to systems and methods for calibrating the TGP based on an optimized topological gap.

A three-step approach for calibrating the topological gap protocol (TGP) is described herein. The first step relates to the optimization of the non-local conductance threshold c₀. The next step relates to the optimization of thermal conductance threshold c_{K}. The third step of the three-pronged approach relates to the optimization of gap threshold c_{Δ}. These steps relate to optimizing stage 2 of the TGP protocol, which focuses on sub-regions of interest with a smaller range of magnetic field values and plunger voltages.

As noted above, the first step includes thresholding the non-local conductance to find the optimal subregions of interest (referred to as SOI₂^{G}), which are part of the ROIs described earlier as part of stage 1 of the TGP. As part of the first step, one thresholds the non-local conductance such that the topological sub-regions of interest (SOI₂) overlap with the region spanned by the scattering invariant (SI) normalized by the union of the two regions. Normalization is used to eliminate the cases in which extremely small subregions of interest (SOIs) are completely covered by the scattering invariant (SI) as well as the cases where SOIs extend beyond the SI region. In other words, the goal is to maximize the cost function Vol(SOI₂^{G}∧SI)/Vol(SOI₂^{G}⊕SI).

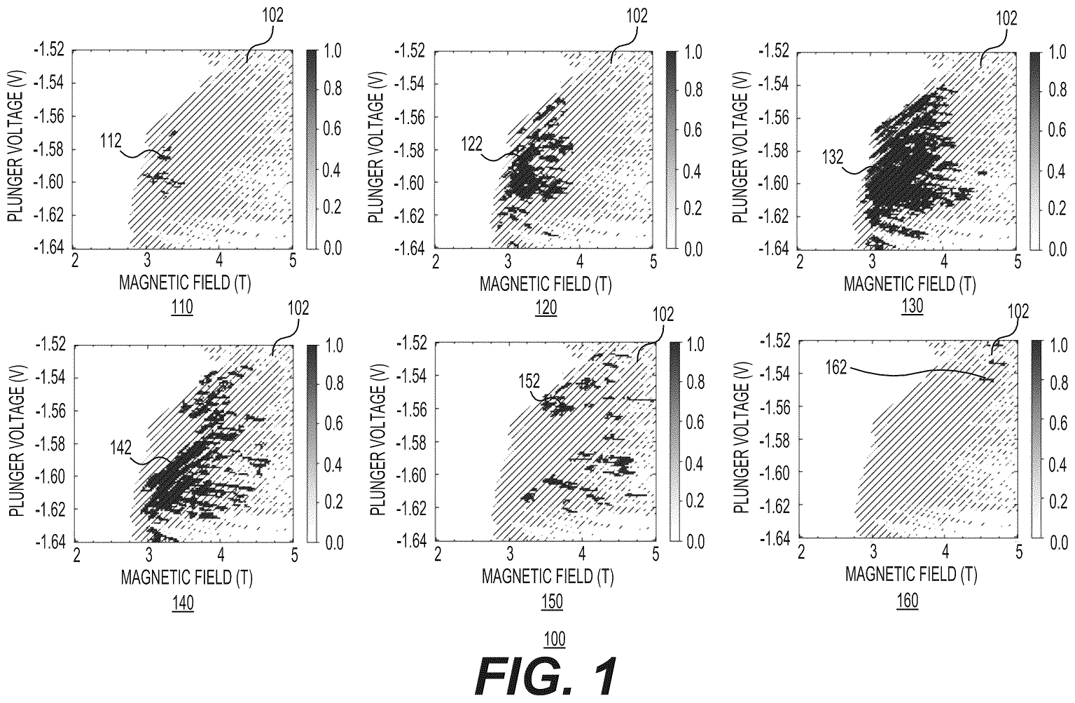

As an example, FIG. 1 shows phase diagrams 100 for different values of the threshold non-local conductance c₀. Phase diagram 110 corresponds to a selected value of the non-local conductance (c₀=0.01). Phase diagram 110 shows a sub-region of interest 112 (dark region) represented by a certain amount of overlap with the scattering invariant 102 (shaded region). Phase diagram 120 corresponds to another selected value of the non-local conductance (c₀=0.02). Phase diagram 120 shows a sub-region of interest 122 (dark region) represented by a certain amount of overlap with the scattering invariant 102 (shaded region). Phase diagram 130 corresponds to another selected value of the non-local conductance (c₀=0.05). Phase diagram 130 shows a sub-region of interest 132 (dark region) represented by a certain amount of overlap with the scattering invariant 102 (shaded region). Phase diagram 140 corresponds to another selected value of the non-local conductance (c₀=0.08). Phase diagram 140 shows a sub-region of interest 142 (dark region) represented by a certain amount of overlap with the scattering invariant 102 (shaded region). Phase diagram 150 corresponds to another selected value of the non-local conductance (c₀=0.1). Phase diagram 150 shows a sub-region of interest 152 (dark region) represented by a certain amount of overlap with the scattering invariant 102 (shaded region). Phase diagram 160 corresponds to another selected value of the non-local conductance (c₀=0.25). Phase diagram 160 shows a sub-region of interest 162 (dark region) represented by a certain amount of overlap with the scattering invariant 102 (shaded region).

As shown in FIG. 1, the goal of thresholding the non-local conductance is to achieve an optimized amount of overlap between the sub-regions of interest (SOI₂) and the scattering invariant (SI). Starting with a smaller value of the non-local conductance threshold (c₀), and then increasing it in small steps allows one to see the range of the overlap between the sub-regions of interest and the scattering invariant. Although FIG. 1 describes the thresholding of the non-local conductance (c₀) using certain values of the non-local conductance (c₀) as examples, these values may vary depending on the design of the hybrid superconductor-semiconductor device. Indeed, similar phase diagrams can be created for each design of a hybrid superconductor-semiconductor device, where different designs can include different stacks and materials. Table 1 below shows examples of the variability among hybrid superconductor-semiconductor devices based on their design and material stacks.

| | | | Other Parameters (length of the wire, |
|---|---|---|---|
| | | | width of the wire, thickness of the oxide, |
| | | | the dielectric constant of the oxide, |
| | | | barrier thickness and composition, |
| | Material | Gate | quantum well thickness, and buffer |
| Device | Stack | Layers | composition and thickness) |
| Device A | Type 1 | Single | Selected values for the one or more of the |
| | | | above parameters |
| Device B | Type 2 | Double | Selected values for the one or more of the |
| | | | above parameters |
| Device C | Type 1 | Double | Selected values for the one or more of the |
| | | | above parameters |
| . . . | . . . | . . . | . . . |
| Device ZZ | Type N | Single | Selected values for the one or more of the |
| | | | above parameters |

As shown in table 1 above, devices can vary from each other in many respects. Each of these devices can be fabricated and simulated in order to observe and record various local and non-local transport properties associated with these devices. In addition, statistical approaches can be used for estimating the unbiased mean and confidence intervals of data with noise. Bootstrap sampling or other techniques can be used to calculate the confidence intervals.

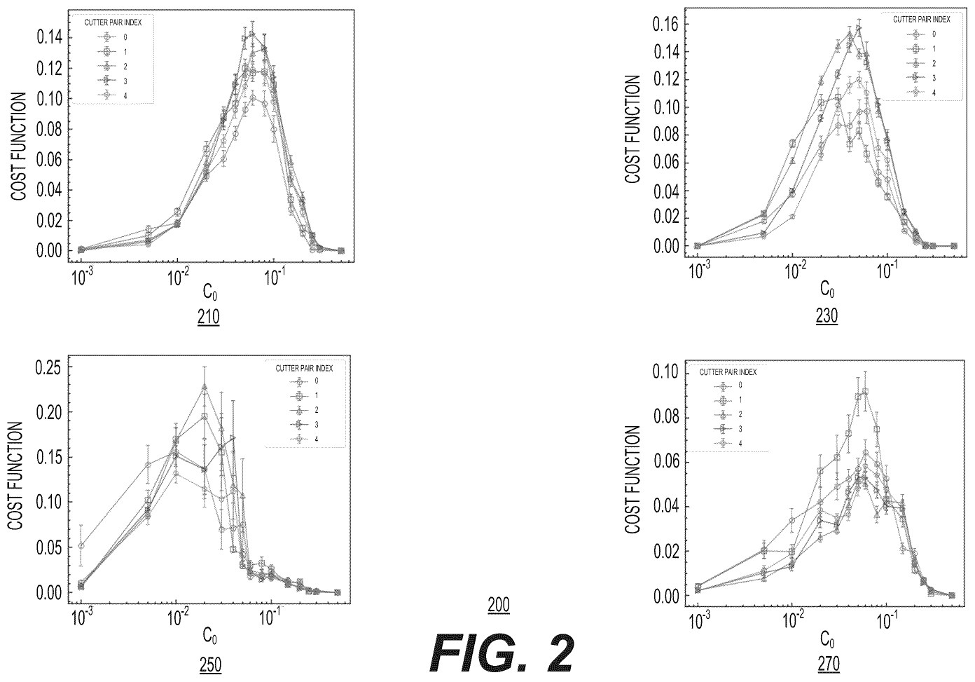

FIG. 2 shows graphs 200 illustrating the results of optimizing the cost function versus the threshold non-local conductance c₀ for different hybrid superconductor-semiconductor device designs. Assuming the three-terminal device has two cutter gates, then a cutter-pair index may be used to track the voltage values for the two cutter gates. In sum, the cutter-pair index can correspond to different pairs of voltage values for the left cutter gate and the right cutter gates. Graphs 200 include graphs 210, 230, 250, and 270, each of which shows the cost function (Vol(SOI₂^{G}∧SI)/Vol(SOI₂^{G}⊕SI)) described earlier with respect to FIG. 1 versus the non-local conductance c₀, also described earlier with respect to FIG. 1.

As shown in graphs 200, the peaks for the plots in each of the graphs show the optimal region for each design. Moreover, graphs 200 illustrate that the optimal threshold value for the non-local conductance is relatively independent of the cutter-pair settings. The different designs of hybrid superconductor-semiconductor can be simulated with different material stacks and disorder levels. The error bars in graphs 200 for each cutter pair index provide information regarding the upper and lower bounds with a 95% confidence level. Graphs 200 further show that as disorder increases, a higher threshold for the non-local conductance c₀ is optimal.

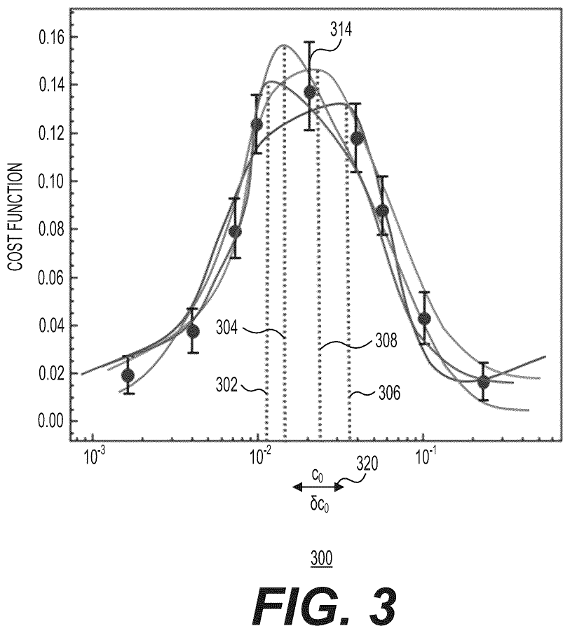

FIG. 3 shows a graph 300 illustrating the propagation of errors from the cost function to the thresholds for non-local conductance c₀ in accordance with one example. Graph 300 can be used to propagate errors from the cost function to the thresholds for non-local conductance c₀ to allow one to observe a distribution of the thresholds for non-local conductance c₀ illustrating the deviation from the mean for the thresholds for non-local conductance c₀ and a standard deviation (δc₀) from that mean. Other measures can also be used to propagate errors from the cost function to the thresholds for non-local conductance c₀. Graph 300 shows dotted lines 302, 304, 306, and 308, each of which corresponds to a peak of one of the four curves shown in FIG. 3. The error bars (e.g., error bar 314) in graph 300 provide information regarding the upper and lower bounds with a 95% confidence level. In one example, the curves shown as part of graph 300 can be obtained via Monte Carlo random sampling. Monte Carlo sampling includes generating random curves by selecting points with uniform probability within the vertical error bars (corresponding to the sets of optimal non-local conductance c₀ values) shown in graphs 200 of FIG. 2. Functions, such as argmax, can be used to find the maximum value for each of these sampled curves. Finally, functions such as STDEV can be used to obtain the standard deviation (δc₀) for the obtained threshold values. Other methods, such as perturbative approximation can also be used to propagate errors from the cost function to the thresholds.

The next step relates to the optimization of thermal conductance threshold c_{K}. To estimate the topological gap, one needs to have access to a baseline (true) gap to which the extracted gap can be compared. In one example, one can use the “thermal gap” for this purpose. Advantageously, one can tune the thermal conductance threshold c_{K} to maximize the overlap between the gapless regions obtained from non-local conductance and the thermal conductance. This allows one to fix the sub-regions of interest (SOI₂^{G}) obtained from the optimization of the threshold non-local conductance c₀. One way to do this is to threshold thermal conductance to find its optimal gapless regions. As part of this example, optimality means maximum overlap between the gapless regions of thermal conductance and non-local conductance. The topological gap Δₘᵢₙ can be viewed as a bar for calling a point gapless, which can be set to a certain value based on the experimental data and other analysis. As an example, this can be achieved by maximizing the value of cost function

$$F ( {c}_{K} ) = \frac{{\sum }_{( B , V )} G ∧ K}{{\sum }_{( B , V )} G ⊕ K} ,$$

where G and K represent the gapless regions' non-local conductance and thermal conductance, respectively. The cost function penalizes if the thermal conductance gapless regions exceed the non-local conductance regions.

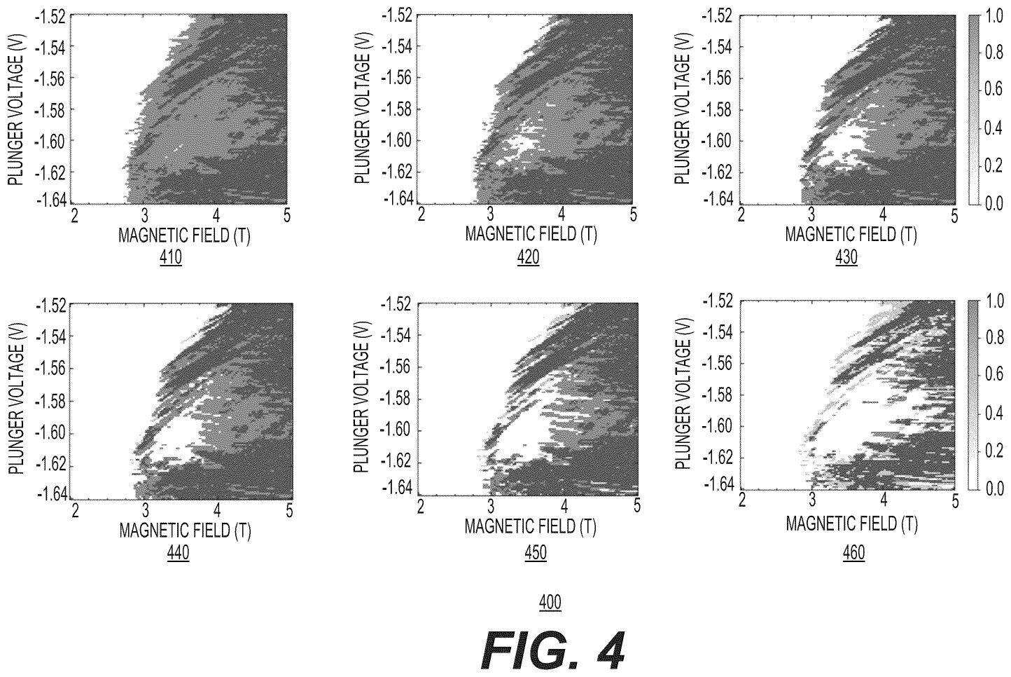

As an example, FIG. 4 shows phase diagrams 400 for different values of the thermal conductance c_{K}. Phase diagram 410 corresponds to a selected value of the thermal conductance (c_{K}=0.01). Phase diagram 410 shows overlap between the gapless regions of thermal conductance (c_{K}) and non-local conductance (c₀). Phase diagram 420 corresponds to a selected value of the thermal conductance (c_{K}=0.05). Phase diagram 420 shows overlap between the gapless regions of thermal conductance (c_{K}) and non-local conductance (c₀). Phase diagram 430 corresponds to a selected value of the thermal conductance (c_{K}=0.08). Phase diagram 430 shows overlap between the gapless regions of thermal conductance (c_{K}) and non-local conductance (c₀). Phase diagram 440 corresponds to a selected value of the thermal conductance (c_{K}=0.15). Phase diagram 440 shows overlap between the gapless regions of thermal conductance (c_{K}) and non-local conductance (c₀). Phase diagram 450 corresponds to a selected value of the thermal conductance (c_{K}=0.2). Phase diagram 450 shows overlap between the gapless regions of thermal conductance (c_{K}) and non-local conductance (c₀). Phase diagram 460 corresponds to a selected value of the thermal conductance (c_{K}=0.3). Phase diagram 460 shows overlap between the gapless regions of thermal conductance (c_{K}) and non-local conductance (c₀).

As shown in FIG. 4, the goal of thresholding the thermal conductance (c_{K}) is to achieve an optimized amount of overlap between the non-local conductance gapless regions associated with the device design and the thermal conductance gapless regions associated with the device design. Starting with a smaller value of the thermal conductance (c_{K}), and then increasing it in small steps allows one to see the range of the overlap between the non-local conductance gapless regions and the thermal conductance gapless regions. Although FIG. 4 describes the thresholding of the thermal conductance (c_{K}) using certain values of the thermal conductance (c_{K}) as examples, these values may vary depending on the design of the hybrid superconductor-semiconductor device. Indeed, similar phase diagrams can be created for each design of a hybrid superconductor-semiconductor device, where different designs can include different stacks and materials. Moreover, instead of the thermal conductance, another suitable reference conductance can also be used to evaluate the amount of overlap between the non-local conductance gapless regions associated with the device design and the reference gapless regions associated with the device design.

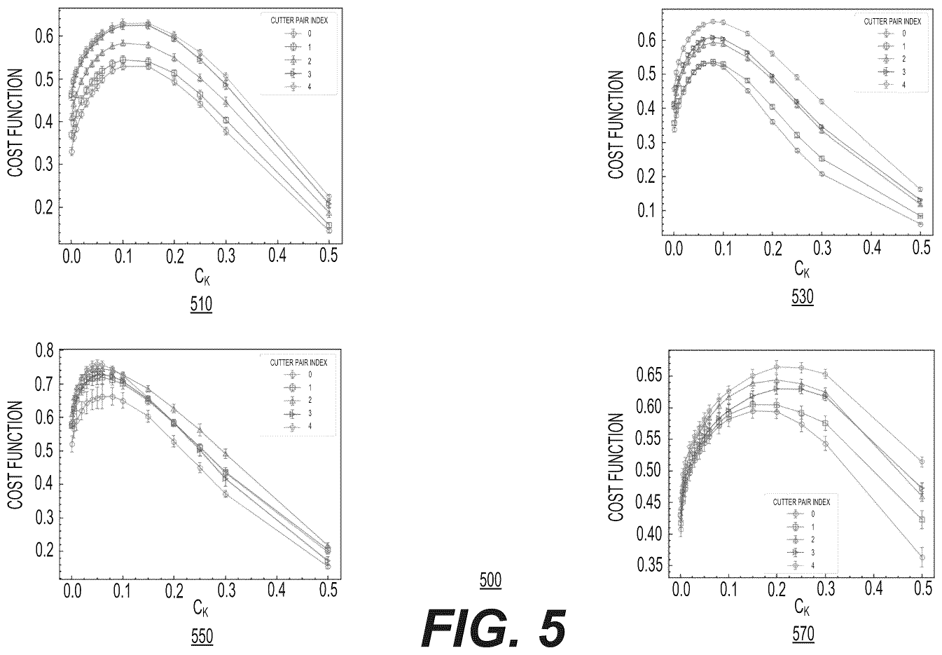

FIG. 5 shows graphs 500 illustrating the results of optimizing the cost function versus the threshold thermal conductance (c_{K}) for different hybrid superconductor-semiconductor device designs. Assuming the three-terminal device has two cutter gates, then a cutter-pair index may be used to track the voltage values for the two cutter gates. In sum, the cutter-pair index can correspond to different pairs of voltage values for the left cutter gate and the right cutter gates. Graphs 500 include graphs 510, 530, 550, and 570, each of which shows the same cost function (Vol(Δ_{G}=0∧Δ_{K}=0)/Vol(Δ_{G}=0⊕Δ_{K}=0)) that is described earlier with respect to FIG. 4. As shown in graphs 500, the peaks for the plots in each of the graphs show the optimal region for each design. Moreover, graphs 500 illustrate that the optimal threshold value for the thermal conductance is relatively independent of the cutter-pair settings. The different designs of hybrid superconductor-semiconductor can be simulated with different material stacks and disorder levels. The error bars in graphs 500 for each cutter pair index provide information regarding the upper and lower bounds with a 95% confidence level. Graphs 500 further show that as disorder increases, a higher threshold for the thermal conductance c_{K} is optimal.

The third step of the three-pronged approach relates to the optimization of the gap threshold c_{Δ}. Now that one has constructed the optimal sub-regions of interest (SOIs) and estimated the baseline gap (Δ_{K}), one can extract the topological gap by varying the final threshold c_{Δ} such that the top quintile (or another range) of the extracted gap maximally matches that of the baseline gap. In other words, one can minimize the norm |Q_{80%}(Δ_{G})−Q_{80%}(Δ_{K})|. The top quintiles are calculated over the intersection of the SOIs obtained in steps 1 and 2 (ROI_{G}∧ROI_{K}). In other words, as part of this step one can fix the regions of interest (ROI₂^{G} and ROI₂^{K}) obtained from the c₀ and c_{K} optimizations described earlier. In addition, one can also fix the value of Δ_{K} obtained from c_{K} optimization. In this example, this is achieved by constructing regions of interest as the intersection of ROI₂^{G} and ROI₂^{K}, namely, ROI₂^{G}∧ROI₂^{K}. These constructed regions are further restricted to only those points where Δ_{K}>Q_{80%}[Δ_{K}] in which Q_{80%} is the top quintile value by specifying these regions of interest via the following equation: ROI=(ROI₂^{G}∧ROI₂^{K})∧(Δ_{K}>Q_{80%}[Δ_{K}]). In sum, this step includes thresholding the non-local conductance such that any of the following two cost functions is minimized:

$${F}_{1} ( {c}_{Δ} ) = \frac{{\sum }_{( B , V ) ∈ ROI} \vert {Δ}_{G} - {Δ}_{K} \vert}{{\sum }_{( B , V ) ∈ ROI} 1} or \qquad ( 1 )$$

$${F}_{2} ( {c}_{Δ} ) = {\vert {Q}_{80 \%} ( {Δ}_{G} ) - {Q}_{80 \%} ( {Δ}_{K} ) \vert}_{( {ROI}_{2}^{G} ∧ {ROI}_{2}^{K} )} . \qquad ( 2 )$$

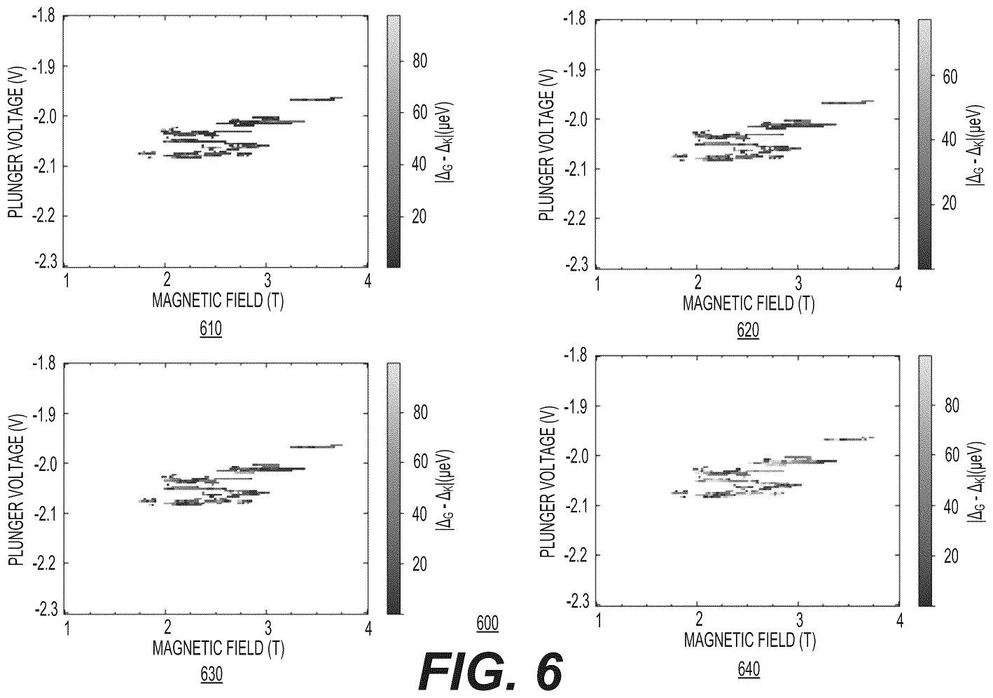

FIG. 6 shows phase diagrams 600 for different values of the topological gap threshold c_{Δ}, which correspond to the difference between the Δ_{G} and the Δ_{K} values. Phase diagram 610 corresponds to a selected value of the gap threshold (c_{Δ}=0.01). The scale next to phase diagram 610 shows a measure of the difference between the Δ_{G} and the Δ_{K} values. Each point in phase diagram 610 can be coded (e.g., color coded) to represent the difference between the Δ_{G} and the Δ_{K} values in order to evaluate the regions of interest that are restricted to only those points where Δ_{K}>Q_{80%}[Δ_{K}] in which Q_{80%} is the top quintile value by specifying these regions of interest via the following equation: ROI=(ROI₂^{G}∧ROI₂^{K})∧(Δ_{K}>Q_{80%}[Δ_{K}]). Phase diagram 620 corresponds to a selected value of the gap threshold (c_{Δ}=0.05). The scale next to phase diagram 620 shows a measure of the difference between the Δ_{G} and the Δ_{K} values. Each point in phase diagram 620 can be coded (e.g., color coded) to represent the difference between the Δ_{G} and the Δ_{K} values in order to evaluate the regions of interest that are restricted to only those points where Δ_{K}>Q_{80%}[Δ_{K}] in which Q_{80%} is the top quintile value by specifying these regions of interest via the following equation: ROI=(ROI₂^{G}∧ROI₂^{K})∧(Δ_{K}>Q_{80%}[Δ_{K}]).

Phase diagram 630 corresponds to a selected value of the gap threshold (c_{Δ}=0.1). The scale next to phase diagram 630 shows a measure of the difference between the Δ_{G} and the Δ_{K} values. Similar to before, each point in phase diagram 630 can be coded (e.g., color coded) to represent the difference between the Δ_{G} and the Δ_{K} values in order to evaluate the regions of interest that are restricted to only those points where Δ_{K}>Q_{80%}[Δ_{K}] in which Q₅ is the top quintile value by specifying these regions of interest via the following equation: ROI=(ROI₂^{G}∧ROI₂^{K})∧(Δ_{K}>Q_{80%}[Δ_{K}]). Phase diagram 640 corresponds to a selected value of the gap threshold (c_{Δ}=0.25). The scale next to phase diagram 640 shows a measure of the difference between the Δ_{G} and the Δ_{K} values. Similar to as before, each point in phase diagram 640 can be coded (e.g., color coded) to represent the difference between the Δ_{G} and the Δ_{K} values in order to evaluate the regions of interest that are restricted to only those points where Δ_{K}>Q_{80%}[Δ_{K}] in which Q_{80%} is the top quintile value by specifying these regions of interest via the following equation: ROI=(ROI₂^{G}∧ROI₂^{K})∧(Δ_{K}>Q_{80%}[Δ_{K}]).

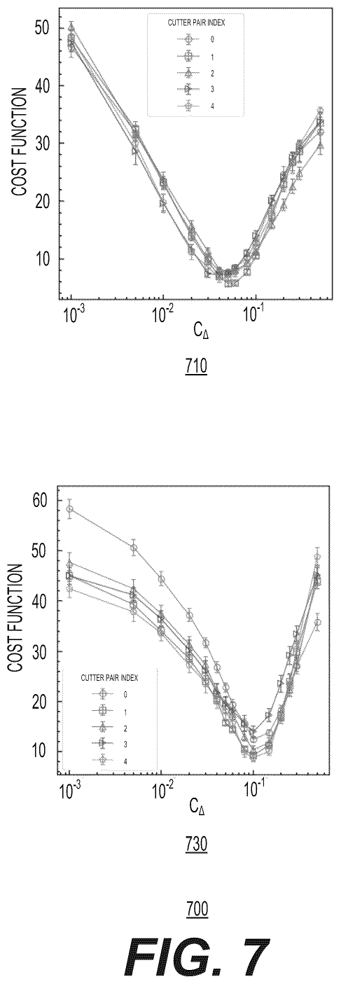

FIG. 7 shows graphs 700 illustrating the results of optimizing the cost function versus the gap threshold (c_{Δ}) for two different hybrid superconductor-semiconductor device designs. As noted earlier, assuming the three-terminal device has two cutter gates, then a cutter-pair index may be used to track the voltage values for the two cutter gates. In sum, the cutter-pair index can correspond to different pairs of voltage values for the left cutter gate and the right cutter gates. Graphs 700 include graphs 710 and 730, each of which shows plots the same cost function

$$( {F}_{1} ( {c}_{Δ} ) = \frac{{\sum }_{( B , V ) ∈ ROI} \vert {Δ}_{G} - {Δ}_{K} \vert}{{\sum }_{( B , V ) ∈ ROI} 1} ) ,$$

which is described earlier with respect to FIG. 6. As shown in graphs 700, the valleys for the plots in each of the graphs show the optimal region for each design. Moreover, graphs 700 illustrate that the optimal threshold value for the gap threshold (c_{Δ}) is relatively independent of the cutter-pair settings. The different designs of hybrid superconductor-semiconductor can be simulated with different material stacks and disorder levels. Graphs 700 further show that as disorder increases, a higher threshold for the gap threshold (c_{Δ}) is optimal.

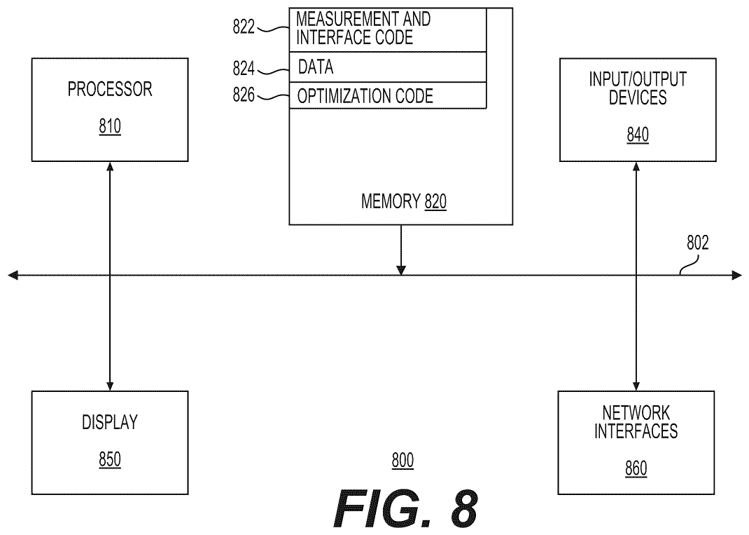

FIG. 8 is a block diagram of a computing system 800 for implementing the steps associated with the calibrating the TGP, as described previously with respect to FIGS. 1-7. As noted earlier, the goal of thresholding the conductance signal is so it can be sufficiently discernable from the inherent noise in the system. Computing system 800 includes a processor 810, a memory 820, input/output devices 840, display 850, and network interfaces 860 interconnected via bus system 802. Memory 820 may include measurement and interface code 822, data 824 (including simulated data, synthetic data, or other types of data used as part of the methods described herein), and optimization code 826. Measurement and interface code 822 may include program instructions that, when executed by processor 810, allow computing system 800 to enable the various aspects of the performance of the methods described herein. In addition, measurement and interface code 822 may include libraries or other code for allowing processor 810 to display relevant information on display 850. Measurement and interface code 822 may also allow input/output devices 840 to receive or transmit information associated with the methods described herein. As an example, data obtained via RD measurements and DC measurements may be obtained.

Optimization code 826 may include instructions for executing steps described with respect to the various optimization steps described herein. As an example, optimization code 826 may include software libraries and other code for executing instructions for performing the three-steps, including the optimizations described with respect to FIGS. 1-7. Although FIG. 8 shows a certain number of components of computing system 800 arranged in a certain way, additional or fewer components arranged differently may also be used. In addition, although memory 820 shows certain blocks of code, the functionality provided by this code may be combined or distributed. In addition, the various blocks of code may be stored in non-transitory computer-readable media, such as non-volatile media and/or volatile media. Non-volatile media include, for example, a hard disk, a solid state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media.

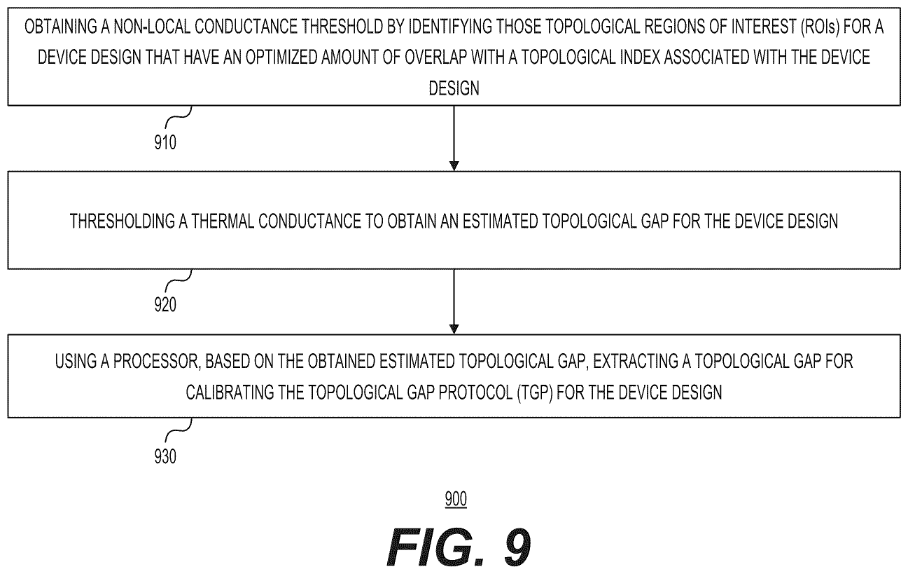

FIG. 9 is a flowchart 900 of a method for calibrating a transport gap protocol (TGP) for a device design. Steps associated with this method can be performed using computing system 800 of FIG. 8 and in view of the further details provided earlier with respect to FIGS. 1-7. Optimization code 826 of FIG. 8 may include instructions for executing the various steps described herein. As an example, optimization code 826 may include software libraries and other code for executing instructions for performing the steps recited as part of this method. Step 910 incudes obtaining a non-local conductance threshold by identifying those topological regions of interest (ROIs) for the device design that have an optimized amount of overlap with a topological index associated with the device design. As explained earlier with respect to FIGS. 1-3, as part this, one thresholds the non-local conductance such that the topological sub-regions of interest (SOI₂) overlap with the region spanned by the scattering invariant (SI) normalized by the union of the two regions. Normalization is used to eliminate the cases in which extremely small subregions of interest (SOIs) are completely covered by the scattering invariant (SI) as well as the cases where SOIs extend beyond the SI region. In other words, the goal is to maximize the cost function Vol(SOI₂^{G}∧SI)/Vol(SOI₂^{G}⊕SI). Additional details for performing some aspects of step 910 are provided with respect to FIGS. 1-3, described earlier.

Step 920 includes thresholding a thermal conductance to obtain an estimated topological gap for the device design. In one example, thresholding the thermal conductance comprises evaluating thermal gapless regions that have an optimized amount of overlap with non-local conductance gapless regions associated with the device design. Thresholding the thermal conductance further comprises maximizing a cost function, where the cost function comprises an intersection of the thermal gapless regions with the non-local conductance gapless regions normalized by a union of the thermal gapless regions with the non-local conductance gapless regions. Additional details regarding these aspects are provided with respect to FIG. 4 and FIG. 5, described earlier.

Step 930 incudes using a processor, based on the obtained estimated topological gap, extracting a topological gap for calibrating the TGP for the device design. Extracting the topological gap comprises varying the topological gap by constructing topological ROIs as an intersection of the identified topological ROIs and the optimal topological ROIs obtained by thresholding the thermal conductance. As part of this process, the constructed topological ROIs are restricted to only those regions of interest that correspond to a top quintile of the estimated topological gap. Additional details regarding these aspects are provided with respect to FIG. 6 and FIG. 7, described earlier.

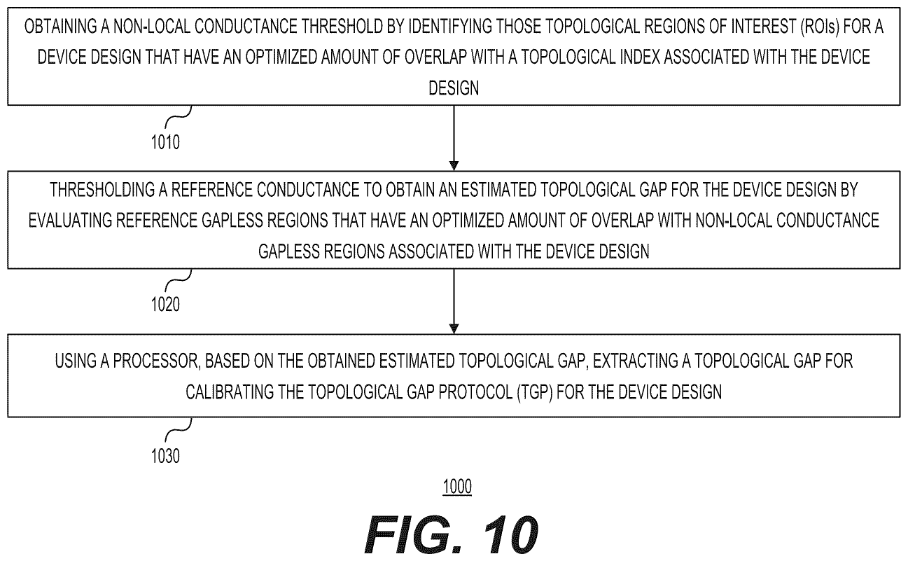

FIG. 10 shows a flowchart 1000 of a method for calibrating a transport gap protocol (TGP) for a device design. Steps associated with this method can be performed using computing system 800 of FIG. 8 and in view of the further details provided earlier with respect to FIGS. 1-7. Optimization code 826 of FIG. 8 may include instructions for executing the various steps described herein. As an example, optimization code 826 may include software libraries and other code for executing instructions for performing the steps recited as part of this method. Step 1010 incudes obtaining a non-local conductance threshold by identifying those topological regions of interest (ROIs) for the device design that have an optimized amount of overlap with a topological index associated with the device design. As explained earlier with respect to FIGS. 1-3, as part this, one thresholds the non-local conductance such that the topological sub-regions of interest (SOI₂) overlap with the region spanned by the scattering invariant (SI) normalized by the union of the two regions. Normalization is used to eliminate the cases in which extremely small subregions of interest (SOIs) are completely covered by the scattering invariant (SI) as well as the cases where SOIs extend beyond the SI region. In other words, the goal is to maximize the cost function Vol(SOI₂^{G}∧SI)/Vol(SOI₂^{G}⊕SI). Additional details for performing some aspects of step 1010 are provided with respect to FIGS. 1-3, described earlier.

Step 1020 includes thresholding a reference conductance to obtain an estimated topological gap for the device design by evaluating reference gapless regions that have an optimized amount of overlap with non-local conductance gapless regions associated with the device design. In one example, thresholding the reference conductance comprises evaluating reference gapless regions that have an optimized amount of overlap with non-local conductance gapless regions associated with the device design. Thresholding the reference conductance further comprises maximizing a cost function, where the cost function comprises an intersection of the reference gapless regions with the non-local conductance gapless regions normalized by a union of the reference conductance gapless regions with the non-local conductance gapless regions. The reference conductance gapless regions include the thermal conductance gapless regions. Additional details regarding these aspects are provided with respect to FIG. 4 and FIG. 5, described earlier.

Step 1030 incudes using a processor, based on the obtained estimated topological gap, extracting a topological gap for calibrating the TGP for the device design. Extracting the topological gap comprises varying the topological gap by constructing topological ROIs as an intersection of the identified topological ROIs and the optimal topological ROIs obtained by thresholding the reference conductance. As part of this process, the constructed topological ROIs are restricted to only those regions of interest that correspond to a top quintile of the estimated topological gap. Additional details regarding these aspects are provided with respect to FIG. 6 and FIG. 7, described earlier.

In conclusion, the present disclosure relates to a method for calibrating a transport gap protocol (TGP) for a device design. The method may include obtaining a non-local conductance threshold by identifying those topological regions of interest (ROIs) for the device design that have an optimized amount of overlap with a topological index associated with the device design.

The method may further include thresholding a thermal conductance to obtain an estimated topological gap for the device design. The method may further include using a processor, based on the obtained estimated topological gap, extracting a topological gap for calibrating the TGP for the device design.

As part of this method, extracting the topological gap comprises varying the topological gap by constructing topological ROIs as an intersection of the identified topological ROIs and ROIs obtained by thresholding the thermal conductance. The method may further comprise restricting the constructed topological ROIs to only those regions of interest that correspond to a top quintile of the estimated topological gap.

The topological index may comprise a scattering invariant associated with the device design. As part of this method, obtaining the non-local conductance threshold may comprise maximizing a cost function, wherein the cost function comprises an intersection of the topological ROIs with the scattering invariant normalized by a union of the topological ROIs with the scattering invariant.

As part of the method, thresholding the thermal conductance may comprise evaluating thermal gapless regions that have an optimized amount of overlap with non-local conductance gapless regions associated with the device design. Thresholding the thermal conductance may comprise maximizing a cost function, wherein the cost function comprises an intersection of thermal gapless regions with non-local conductance gapless regions normalized by a union of the thermal gapless regions with the non-local conductance gapless regions'

In another example, the present disclosure relates to a method for calibrating a transport gap protocol (TGP) for a device design. The method may include obtaining a non-local conductance threshold by identifying those topological regions of interest (ROIs) for the device design that have an optimized amount of overlap with a topological index associated with the device design.

The method may further include thresholding a reference conductance to obtain an estimated topological gap for the device design by evaluating reference gapless regions that have an optimized amount of overlap with non-local conductance gapless regions associated with the device design. The method may further include using a processor, based on the obtained estimated topological gap, extracting a topological gap for calibrating the TGP for the device design.

As part of this method, extracting the topological gap comprises varying the topological gap by constructing topological ROIs as an intersection of the identified topological ROIs and ROIs obtained by thresholding the reference conductance. The method may further comprise restricting the constructed topological ROIs to only those regions of interest that correspond to a top quintile of the estimated topological gap.

The topological index may comprise a scattering invariant associated with the device design. Obtaining the non-local conductance threshold may comprise maximizing a cost function, wherein the cost function comprises an intersection of the topological ROIs with the scattering invariant normalized by a union of the topological ROIs with the scattering invariant. As part of the method, the thresholding the reference conductance may also comprise maximizing a cost function, wherein the cost function comprises an intersection of the reference gapless regions with the non-local conductance gapless regions normalized by a union of the reference gapless regions with the non-local conductance gapless regions.

In yet another example, the present disclosure relates to a method for calibrating a transport gap protocol (TGP) for a device design. The method may include obtaining a non-local conductance threshold by identifying those topological regions of interest (ROIs) for the device design that have an optimized amount of overlap with a topological index associated with the device design.

The method may further include thresholding a thermal conductance value to obtain an estimated topological gap for the device design by evaluating thermal conductance gapless regions that have an optimized amount of overlap with non-local conductance gapless regions associated with the device design. The method may further include using a processor, based on the obtained estimated topological gap and the obtained optimal topological ROIs, extracting a topological gap for calibrating the TGP for the device design.

As part of the method, extracting the topological gap may comprise varying the topological gap by constructing topological ROIs as an intersection of the identified topological ROIs and ROIs obtained by thresholding the thermal conductance. The method may further comprise restricting the constructed topological ROIs to only those regions of interest that correspond to a top quintile of the estimated topological gap.

The topological index may comprise a scattering invariant associated with the device design. Obtaining the non-local conductance threshold may comprise maximizing a cost function, wherein the cost function comprises an intersection of the topological ROIs with the scattering invariant normalized by a union of the topological ROIs with the scattering invariant.

As part of this method, the thresholding the thermal conductance may comprise maximizing a cost function, wherein the cost function comprises an intersection of the thermal gapless regions with the non-local conductance gapless regions normalized by a union of the thermal gapless regions with the non-local conductance gapless regions. The method may further comprise evaluating the device design using the calibrated TGP.

It is to be understood that the systems, devices, methods, and components described herein are merely examples. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality. Merely because a component, which may be an apparatus, a structure, a device, a system, or any other implementation of a functionality, is described herein as being coupled to another component does not mean that the components are necessarily separate components. As an example, a component A described as being coupled to another component B may be a sub-component of the component B, the component B may be a sub-component of the component A, or components A and B may be a combined sub-component of another component C.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed:

1. A method for calibrating a transport gap protocol (TGP) for a device design, the method comprising:
obtaining a non-local conductance threshold by identifying those topological regions of interest (ROIs) for the device design that have an optimized amount of overlap with a topological index associated with the device design;
thresholding a thermal conductance to obtain an estimated topological gap for the device design; and
using a processor, based on the obtained estimated topological gap, extracting a topological gap for calibrating the TGP for the device design.

2. The method of claim 1, wherein extracting the topological gap comprises varying the topological gap by constructing topological ROIs as an intersection of the identified topological ROIs and ROIs obtained by thresholding the thermal conductance.

3. The method of claim 2, further comprising restricting the constructed topological ROIs to only those regions of interest that correspond to a top quintile of the estimated topological gap.

4. The method of claim 1, wherein the topological index comprises a scattering invariant associated with the device design.

5. The method of claim 4, wherein obtaining the non-local conductance threshold comprises maximizing a cost function, wherein the cost function comprises an intersection of the topological ROIs with the scattering invariant normalized by a union of the topological ROIs with the scattering invariant.

6. The method of claim 1, wherein the thresholding the thermal conductance comprises evaluating thermal gapless regions that have an optimized amount of overlap with non-local conductance gapless regions associated with the device design.

7. The method of claim 1, wherein the thresholding the thermal conductance comprises maximizing a cost function, wherein the cost function comprises an intersection of thermal gapless regions with non-local conductance gapless regions normalized by a union of the thermal gapless regions with the non-local conductance gapless regions.

8. A method for calibrating a transport gap protocol (TGP) for a device design, the method comprising:
obtaining a non-local conductance threshold by identifying those topological regions of interest (ROIs) for the device design that have an optimized amount of overlap with a topological index associated with the device design;
thresholding a reference conductance to obtain an estimated topological gap for the device design by evaluating reference gapless regions that have an optimized amount of overlap with non-local conductance gapless regions associated with the device design; and
using a processor, based on the obtained estimated topological gap, extracting a topological gap for calibrating the TGP for the device design.

9. The method of claim 8, wherein extracting the topological gap comprises varying the topological gap by constructing topological ROIs as an intersection of the identified topological ROIs and ROIs obtained by thresholding the reference conductance.

10. The method of claim 9, further comprising restricting the constructed topological ROIs to only those regions of interest that correspond to a top quintile of the estimated topological gap.

11. The method of claim 8, wherein the topological index comprises a scattering invariant associated with the device design.

12. The method of claim 11, wherein obtaining the non-local conductance threshold comprises maximizing a cost function, wherein the cost function comprises an intersection of the topological ROIs with the scattering invariant normalized by a union of the topological ROIs with the scattering invariant.

13. The method of claim 8, wherein the thresholding the reference conductance comprises maximizing a cost function, wherein the cost function comprises an intersection of the reference gapless regions with the non-local conductance gapless regions normalized by a union of the reference gapless regions with the non-local conductance gapless regions.

14. A method for calibrating a transport gap protocol (TGP) for a device design, the method comprising:
obtaining a non-local conductance threshold by identifying those topological regions of interest (ROIs) for the device design that have an optimized amount of overlap with a topological index associated with the device design;
thresholding a thermal conductance value to obtain an estimated topological gap for the device design by evaluating thermal conductance gapless regions that have an optimized amount of overlap with non-local conductance gapless regions associated with the device design; and
using a processor, based on the obtained estimated topological gap, extracting a topological gap for calibrating the TGP for the device design.

15. The method of claim 14, wherein extracting the topological gap comprises varying the topological gap by constructing topological ROIs as an intersection of the identified topological ROIs and ROIs obtained by thresholding the thermal conductance.

16. The method of claim 15, further comprising restricting the constructed topological ROIs to only those regions of interest that correspond to a top quintile of the estimated topological gap.

17. The method of claim 14, wherein the topological index comprises a scattering invariant associated with the device design.

18. The method of claim 17, wherein obtaining the non-local conductance threshold comprises maximizing a cost function, wherein the cost function comprises an intersection of the topological ROIs with the scattering invariant normalized by a union of the topological ROIs with the scattering invariant.

19. The method of claim 14, wherein the thresholding the thermal conductance comprises maximizing a cost function, wherein the cost function comprises an intersection of the thermal gapless regions with the non-local conductance gapless regions normalized by a union of the thermal gapless regions with the non-local conductance gapless regions.

20. The method of claim 14, further comprising evaluating the device design using the calibrated TGP.
